(19) United States
(12) Patent Application Publication
(10) Pub. No.: US 2013/0023231 A1
(43) Pub. Date: Jan. 24, 2013

(54) SIM CARD EXPANDER, COMMUNICATION SYSTEM, AND METHOD FOR USING SIM CARDS

(71) Applicant: JIAN-GUO ZHU, Shenzhen City (CN)

(72) Inventor: JIAN-GUO ZHU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/241,168

(22) Filed: Sep. 22, 2011

(30) Foreign Application Priority Data
Jul. 22, 2011 (CN) 201110206663.5

(51) Int. Cl. H04W 88/02; H04W 24/00

(52) U.S. Cl. 455/406; 455/558

(57) ABSTRACT

A SIM card expander includes SIM card connectors for receiving SIM cards, and a control unit. The control unit includes a detecting module to detect whether the SIM card expander is electrically connected to a communication device, an obtaining module to obtain information of the SIM cards received in the SIM card connectors once determining that the SIM card expander is electrically connected to the communication device, a transmitting module to transmit the obtained information of the SIM cards to the communication device, and a power management module to determine which of the SIM card connectors receives a selected SIM card according a feedback signal from the communication device, enable electrical connection of the SIM card connector which receives the selected SIM card and a power source of the communication device, and disable electrical connection of the other SIM card connectors and the power source of the communication device.

### BACKGROUND

1. Technical Field

The present disclosure relates to a SIM card expander, a communication system using the SIM card expander, and a method for using SIM cards.

2. Description of Related Art

Although a mobile phone with a number of SIM cards therein can satisfy basic requirements, a mobile phone with a new type of SIM card expander is still desired.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a communication system using a SIM card expander, in accordance with an exemplary embodiment.

FIG. 2 is a schematic view showing a user interface provided by a communication device of the communication system of FIG. 1, in accordance with an exemplary embodiment.

FIG. 3 is a flowchart of a method for using SIM cards, in accordance with an exemplary embodiment.

### DETAILED DESCRIPTION

Embodiments of the present disclosure are now described in detail, with reference to the accompanying drawings.

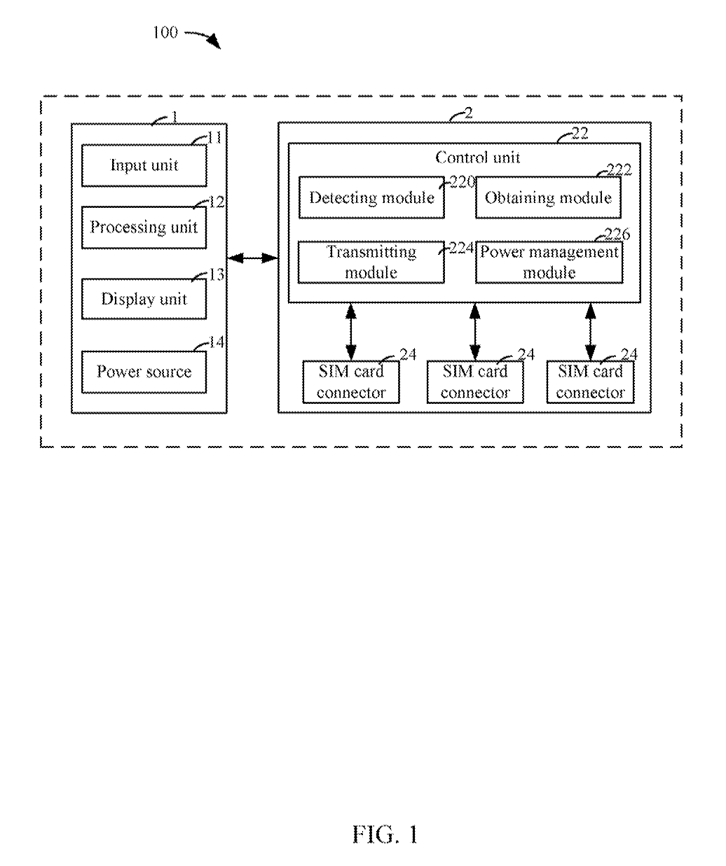

Referring to FIG. 1, a communication system 100 with a SIM card expander 2 according to an exemplary embodiment is illustrated. The communication system 100 includes a communication device 1 and the SIM card expander 2 coupled to the communication device 1. In the embodiment, the communication device 1 may be a mobile phone.

The communication device 1 includes an input unit 11, a processing unit 12, a display unit 13, and a power source 14. The input unit 11 is for a user to input commands to the communication device 1. The display unit 13 is for displaying information. The power source 14 provides power to the communication system 100.

The SIM card expander 2 includes a control unit 22 and at least two SIM card connectors 24 for receiving one or more SIM cards (not shown). The control unit 22 includes a detecting module 220, an obtaining module 222, a transmitting module 224, and a power management module 226.

The detecting module 220 detects whether the SIM card expander 2 is electrically connected to the communication device 1.

Once the detecting module 220 determines that the SIM card expander 2 is electrically connected to the communication device 1, the obtaining module 222 obtains information of the one or more SIM cards received in the SIM card connectors 24. In the embodiment, the information of each SIM card may include a phone number of the SIM card, an operator of the SIM card, an available balance of the SIM card, and so on.

The transmitting module 224 transmits the obtained information of the one or more SIM cards to the communication device 1.

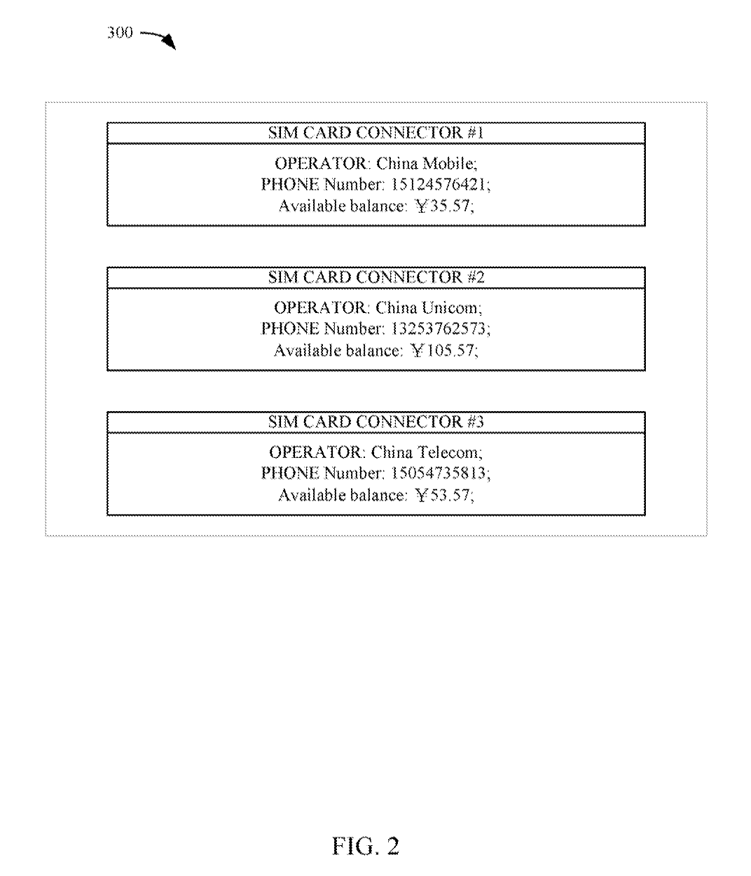

Referring to FIG. 2, the processing unit 12 displays a user interface 300 on the display unit 13 to show the information from the SIM card expander 1 for a user to select a SIM card to be used. In the embodiment, the user selects the SIM card via the input unit 11. If one SIM card is selected, the processing unit 12 generates a feedback signal indicating the selected SIM card and the SIM card connector 24 which receives the selected SIM card, and sends the feedback signal to the power management module 226.

The power management module 226 determines which of the at least two SIM card connectors 24 receives the selected SIM card according to the feedback signal from the communication device 2. The power management module 226 further enables electrical connection between the power source 14 and the SIM card connector 24 which receives the selected SIM card, and disables electrical connection between the power source 14 and the other SIM card connectors 24 if such electrical connection exists. After electrical connection between the power source 14 and the SIM card connector 24 which receives the selected SIM card is enabled, the selected SIM card is activated.

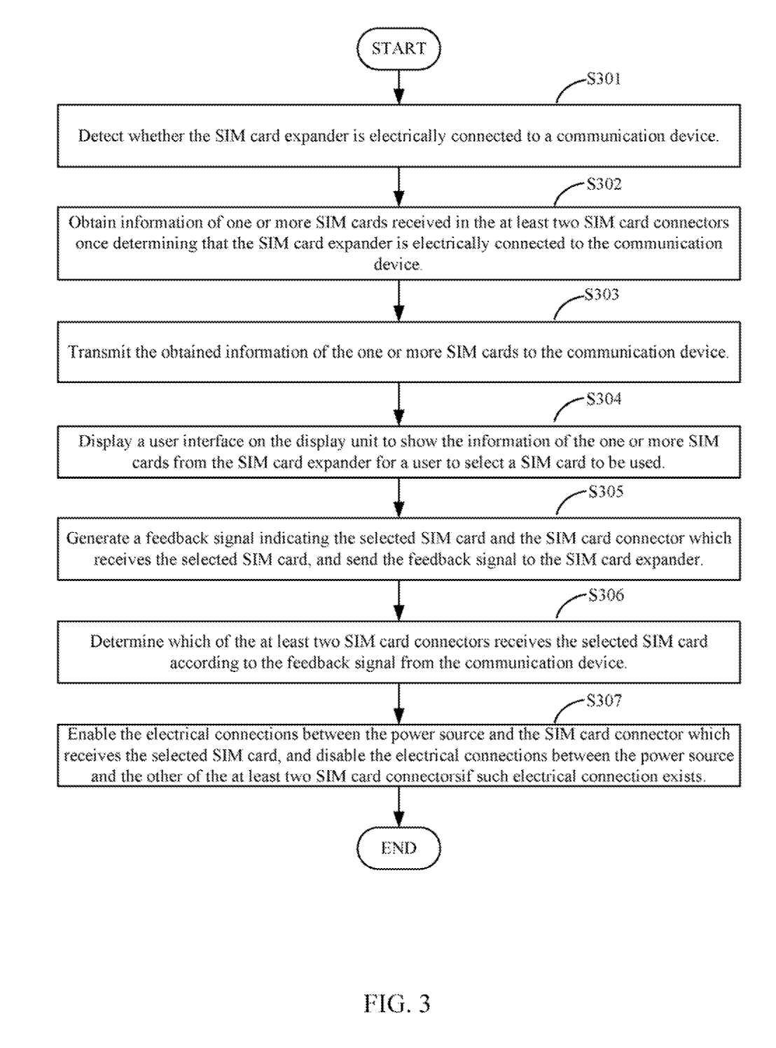

Referring to FIG. 3, a flowchart of a method for enabling a SIM card applied in a communication system 100 in accordance with an exemplary embodiment is illustrated.

In step S301, the detecting module 220 detects whether the SIM card expander 2 is electrically connected to a communication device 1.

In step S302, the obtaining module 222 obtains information of the one or more SIM cards received in the at least two SIM card connectors 24 once the detecting module 220 determines that the SIM card expander 2 is electrically connected to the communication device 1.

In step S303, the transmitting module 224 transmits the obtained information of the one or more SIM cards to the communication device 1.

In step S304, the processing unit 12 displays the user interface 300 on the display unit 13 to show the information of the one or more SIM cards from the SIM card expander 1 for a user to select a SIM card to be used.

In step S305, the processing unit 12 generates the feedback signal indicating the selected SIM card and the SIM card connector 24 which receives the selected SIM card, and sends the feedback signal to the power management module 226.

In step S306, the power management module 226 determines which of the at least two SIM card connectors 24 receives the selected SIM card according to the feedback signal from the communication device 2.

In step S307, the power management module 226 enables electrical connection between the power source 14 and the SIM card connector 24 which receives the selected SIM card, and disables electrical connections between the power source 14 and the other SIM card connectors 24 if such electrical connection exists.

While various embodiments have been described and illustrated, the disclosure is not to be constructed as being limited thereto. Various modifications can be made to the embodiments by those skilled in the art without departing from the true spirit and scope of the disclosure as defined by the appended claims.

1. A SIM card expander comprising:
at least two SIM card connectors for receiving one or more SIM cards; and
a control unit comprising:
a detecting module to detect whether the SIM card expander is electrically connected to a communication device;
an obtaining module to obtain information of the one or more SIM cards received in the at least two SIM card connectors once the detecting module determines that the SIM card expander is electrically connected to the communication device;
a transmitting module to transmit the obtained information of the one or more SIM cards to the communication device; and
a power management module to determine which one of the at least two SIM card connectors receives a selected one of the one or more SIM cards according a feedback signal from the communication device, enable electrical connection of the one of the at least two SIM card connectors which receives the selected one of the one or more SIM cards and a power source of the communication device, and disable electrical connection of another one of the at least two SIM card connectors and the power source of the communication device if such electrical connection exists.

2. The SIM card expander as described in claim 1, wherein the information of each of the one or more SIM cards comprises a phone number of each of the one or more SIM cards, an operator of each of the one or more SIM cards, and an available balance of each of the one or more SIM cards.

3. A communication system comprising:
a communication device comprising:
a power source to provide power to the communication system; and
a processing unit; and
a SIM card expander comprising:
at least two SIM card connectors for receiving one or more SIM cards; and
a control unit comprising:
a detecting module to detect whether the SIM card expander is electrically connected to the communication device;
an obtaining module to obtain information of the one or more SIM cards received in the at least two SIM card connectors once the detecting module determines that the SIM card expander is electrically connected to the communication device;
a transmitting module to transmit the obtained information of the one or more SIM cards to the communication device; and
a power management module;
wherein the processing unit displays on a user interface of the communication device the obtained information of the one or more SIM cards from the SIM card expander for a user to select one of the one or more SIM cards to be used, generates a feedback signal indicating the selected SIM card one of the one or more SIM cards and the one of the at least two SIM card connectors which receives the selected one of the one or more SIM cards, and transmits the feedback signal to the power management module; and
wherein the power management module determines which of the at least two SIM card connectors receives the selected SIM card according to the feedback signal, enables electrical connection between the SIM card connector which receives the selected SIM card and the power source, and further disables electrical connection between another one of the at least two SIM card connectors and the power source if such electrical connection exists.

4. The communication system as described in claim 3, wherein the communication device is a mobile phone.

5. The communication system as described in claim 3, wherein the communication device comprises a display unit to display the obtained information for the user to select one of the one or more SIM cards to be used.

6. The communication system as described in claim 3, wherein the communication device further comprises an input unit for the user to select the one of the one or more SIM cards to be used.

7. The communication system as described in claim 3, wherein the information of each of the one or more SIM cards comprises a phone number of each of the one or more SIM cards, an operator of each of the one or more SIM cards, and an available balance each of the one or more SIM cards.

8. A method for selecting a SIM card to be used applied in a communication system, the communication system comprising a SIM card expander and a communication device, the SIM card expander comprising at least two card connectors for receiving one or more SIM cards, the method comprising:
detecting whether the SIM card expander is electrically connected to the communication device;
obtaining information of the one or more SIM cards received within the at least two SIM card connectors once determining that the SIM card expander is electrically connected to the communication device;
transmitting the obtained information of the one or more SIM cards to the communication device;
displaying on a user interface of the communication device the obtained information for the user to select one of the one or more SIM cards to be used;
generating a feedback signal indicating the selected SIM card and the SIM card connector which receives the selected SIM card, and sending the feedback signal to the SIM card expander;
determining which of the at least two SIM card connectors receives the selected SIM card according to the feedback signal from the communication device; and
enabling electrical connections between the power source and the SIM card connector which receives the selected one of the one or more SIM cards, and disabling electrical connections between the power source and another one of the at least two SIM card connectors.

9. The expanding method as described in claim 8, wherein the information of each of the one or more SIM cards comprises a phone number of each of the one or more SIM cards, an operator of each of the one or more SIM cards, and an available balance of each of the one or more SIM cards.
